(19) United States
(12) Patent Application Publication
(10) Pub. No.: US 2009/0043693 A1
(43) Pub. Date: Feb. 12, 2009

(54) System and Method for Licensing Fee Distribution

(76) Inventors: Barney J. NG, Jackson, WY (US); Matthew C. KELLY, Walnut Creek, CA (US); Peter J. JOHNSON, Reno, NV (US); Eric F. BENDALL, Reno, NV (US)

Correspondence Address: GREENBERG TRAURIG, LLP (SV);IP DOCKETING, 2450 COLORADO AVENUE, SUITE 400E, SANTA MONICA, CA, 90404, US

(21) Appl. No.: 11/835,401

(22) Filed: Aug. 7, 2007

(51) Int. Cl. G06Q 40/00; G06F 17/40

(52) U.S. Cl. 705/39

(57) ABSTRACT

A method, machine-readable medium and system for distributing licensing fees are described. According to one embodiment, the system includes: a content presentation system comprising a server coupled to content presentation terminals to present content; a means for receiving licensing fees from a licensee of the content presentation system; a means for distributing a portion of the licensing fees into a licensing fund; a means for tracking cumulative times each content is made available over all of the content presentation terminals in a period; a means for tracking total cumulative time for all the interactive programs over all of the content presentation terminals in a period; and a means for distributing a share of the licensing fund to each of the licensors of the content, the share of the licensing fund based on the fraction of the cumulative time for the corresponding content divided by the total cumulative time.

### BACKGROUND

1. Field of the Invention

This invention relates generally to the field of business methods. More particularly, the invention relates to a method and apparatus for licensing fee distribution for an event processing system.

2. Description of the Related Art

A typical casino uses conventional, stand-alone style slot machines, which require a significant financial investment to purchase. What is needed are less expensive gaming machines.

These conventional, stand-alone style slot machines are generally fixed to play a particular variation of traditional slot machine games. These traditional slot machine games are not as attractive to younger generations of casino customers. What are needed are games that are more attractive to these younger generations. What is needed is improved game quality and fresh choices for customers.

### SUMMARY

A method, machine-readable medium and system for distributing licensing fees are described. According to one embodiment, the system includes: a content presentation system comprising a server coupled to content presentation terminals to present content; a means for receiving licensing fees from a licensee of the content presentation system; a means for distributing a portion of the licensing fees into a licensing fund; a means for tracking the cumulative time each content is available for presentation on each content presentation terminal over all of the content presentation terminals in a period; a means for tracking total cumulative time for all the content over all of the content presentation terminals in a period; and a means for distributing a share of the licensing fund to each of the licensors of the content, the share of the licensing fund based on the fraction of the cumulative time for the corresponding content divided by the total cumulative time.

### BRIEF DESCRIPTION OF THE DRAWINGS

These and other features, aspects, and advantages of the present invention will become better understood with regard to the following description, appended claims, and accompanying drawings where:

FIG. 1 is a block diagram of one embodiment of a system for distributing licensing fees to content licensors.

FIG. 2 is s a flow chart of one embodiment of a method for distributing licensing fees to content licensors.

FIG. 3 is a diagrammatic representation of a machine of the present invention in the exemplary form of a computer system.

FIG. 4 shows a block diagram of one embodiment of a content presentation system of the present invention.

FIG. 5 is a flow chart of one embodiment of a content presentation method of the invention.

FIG. 6 is a flow chart of method of tracking cumulative time each content is available for presentation on a content presentation terminal according to one embodiment of the invention.

### DETAILED DESCRIPTION OF PREFERRED EMBODIMENTS

At least some embodiments of the disclosure relate to a method and apparatus for distributing licensing fees.

The following description and drawings are illustrative and are not to be construed as limiting. Numerous specific details are described to provide a thorough understanding of the disclosure. However, in certain instances, well known or conventional details are not described in order to avoid obscuring the description. References to one or an embodiment in the present disclosure can be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Traditional game content is typically developed and wholly owned by a slot machine manufacturer. This ownership model inhibits new game content development because game content creators and slot machine manufacturers must agree upon a content compensation pact prior to deploying new game content in an operational casino. As such, it is very difficult to strike an equitable risk-to-reward balance between the game developer and the slot machine manufacturer. A more flexible game content compensation model based upon relative availability of each game offered to customers would reduce the financial risk associated with fixed price purchases of game content and would create a game development and deployment environment better suited to encourage fresh game content from new game developers.

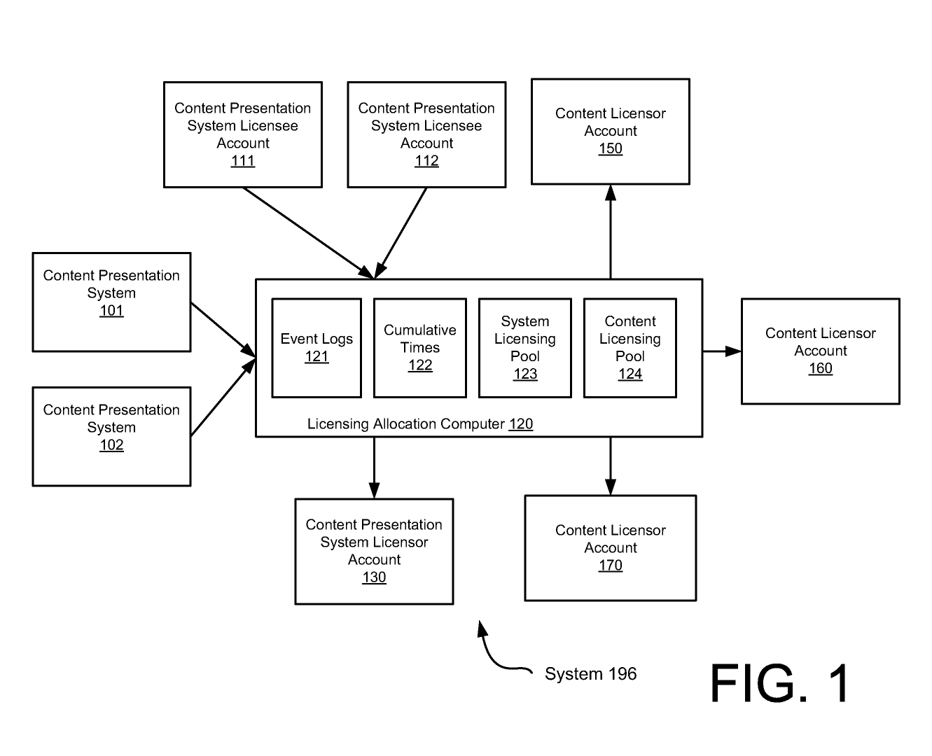

FIG. 1 illustrates one embodiment of a licensing distribution system of the present invention.

A system 196 includes content presentation system 101 and a content presentation system 102. Each content presentation system includes one or more content presentation terminals. Each content presentation terminal is configured to present content available for presentation on that content presentation terminal. In one embodiment, the content includes interactive games. In other embodiments, the content is interactive advertising, non-interactive advertising or other multimedia content, for example. In one embodiment, content is served to the content presentation terminals by a server using an event-response protocol. The server maintains state information to indicate which of the content on the server is available for presentation on each content presentation terminal. In one embodiment, a user selects among more than one content available for presentation on that content presentation terminal. In another embodiment, only one content is available for presentation on each content presentation terminal at any given time. In one embodiment, only a subset of the content on the server is available on a given content presentation terminal at any given time and that subset may change from time to time independently for each content presentation terminal. For example, the system may be configured to automatically change the availability on the content presentation terminals according to a predetermined schedule. Other systems for distributing content may be used.

The content presentation system licensee account 111 is an account of the licensee of the content presentation system 101. The content presentation system licensee account 112 is an account of the licensee of the content presentation system 102. A periodic payment of the licensing fee is from each licensee account is transferred to the licensing allocation computer 120. A portion of the periodic payment is allocated to a system licensing pool 123 and another portion to a content licensing pool 124 under the terms of a licensing agreement. The system licensing pool 123 is transferred to a content presentation system licensor account 130 to compensate the licensor of the content presentation systems. The content licensing pool 124 is distributed among the content licensors. A content licensor account 150, a content licensor account 160 and a content licensor account 170 represent the accounts for three content licensors. In one embodiment, the content licensing pool 124 is distributed among the content licensor accounts based on the proportion of time each content was available for presentation on each content presentation terminal over all the content presentation terminals over all the content presentation systems.

In one embodiment, a single fund is created by accumulating all the licensing funds received for the period. In another embodiment, the funds for each licensee deposited into separate funds and each fund is processed separately.

In one embodiment, payments and transfers are made using electronic funds transfers. In another embodiment, payments are made using checks issued by the accounts payable department of the licensees. Other methods of making payments and fund transfers may be used.

In one embodiment, each content presentation system generates an event log including the time each content was made available and the time each content was made unavailable on each content presentation terminal. In some cases, one content is available on each content presentation terminal at any given time. In another embodiment, more than one content is available on each content presentation terminal at a given time. A user of the corresponding content presentation terminal selects one of the more than one available content for presentation at any given time.

At the end of a reporting period, each event log is transferred to a licensing allocation computer 120. In one embodiment, the content presentation systems are under the control of the content presentation system licensee and the licensing allocation computer is under the control of the content presentation system licensor. In some cases, the licensee is contractually obligated to transfer event logs to the licensor promptly at the end of each reporting period.

In one embodiment, the licensee transfers the event log to the licensing allocation computer 120 by email. In another embodiment, the event logs are transferred from each content presentation system to the licensing allocation computer 120 automatically over the internet after the end of each reporting period. The licensing allocation computer 120 processes the event logs 121 to generate cumulative times 122. In one embodiment, each time in the cumulative times 122 represents the cumulative time that each content was available on each content presentation terminal in each content presentation system during the reporting period. In other embodiments, the cumulative times 122 include times that represent the cumulative time for each content aggregated over more than one content presentation terminal and/or more than one content presentation system.

In some embodiments, the event logs may contain information in addition to the times content was made available and the times content was made unavailable on each content presentation terminal. However, in one embodiment, the event logs do not contain information that the licensee considers confidential. In one embodiment of a content presentation system configured to present game content for a gambling system, the event logs do not contain information about the type of game play, the amount of any bets, or information about the players.

In some embodiments, the content presentation system computes the cumulative time that each content was available on each content presentation terminal by processing the event log.

The precision of cumulative time measurements can be selected to achieve acceptable precision in the calculation of licensing share according to the described method. For example, the precision of the time measurements may be one or more seconds or one or more minutes. In some jurisdictions, the minimum time a game must be available is set by law. In one embodiment, the precision of the cumulative time measurements is set to the minimum time the game must be available in the local jurisdiction.

A content one licensor 150 licensees a first content, a content two licensor 160 licenses a second content, and a content three licensor licenses a third content. The funds in the content licensing pool 110 are distributed among the content one licensor 150, the content two licensor 160 and the content three licensor 170 according to the share of total cumulative time the corresponding content was available on each of the content presentation terminals. In one embodiment, the share is computed over all content on all content presentation terminals in more than one content presentation system. This share is used to distribute funds in the content licensing fund 140 that is accumulated over the plurality of content presentation systems. In another embodiment, the share is computed over all content on all content presentation terminals in a single content presentation system. This share is used to distribute funds in the content licensing fund 140 that is accumulated for that particular content presentation system.

This example illustrates two content presentation systems, two content presentation system licensees and three content licensors. However, this invention can be practiced with more or less content presentation systems, content presentation system licensees and content licensors.

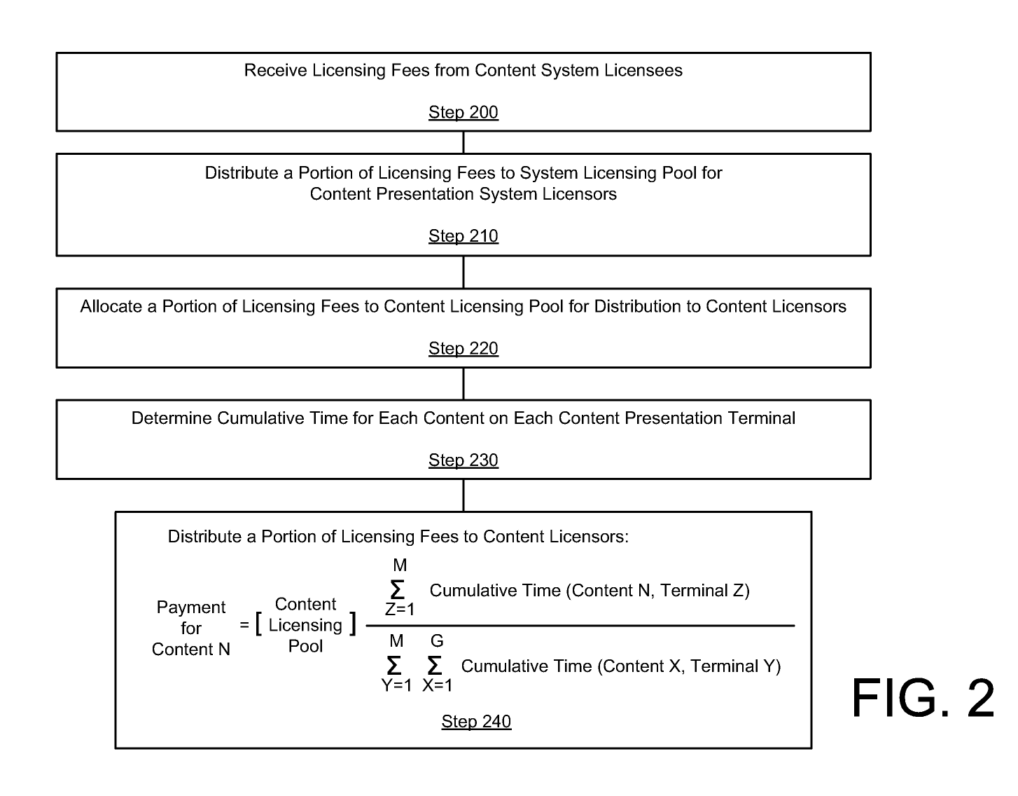

FIG. 2 illustrates one embodiment of a licensing fee distribution method of the present invention.

In step 200, licensing fees from the content presentation system licensees are received. In some cases, the same content presentation system licensee may license more than one content presentation system. In that case, licensing payments can be aggregated accordingly. In one embodiment, transfers may be made via electronics funds transfers. In another embodiment, payments may be made by check. In one embodiment, each content presentation system licensee pays a flat fee per content presentation terminal per day across all the content presentation systems licensed by the licensee. Other methods of determining the licensing fee may be used.

In step 210, a portion of the licensing fees are allocated to a system licensing pool for distribution to one or more content presentation system licensors. In some cases, the same content presentation system licensor may be responsible for more than one content presentation system. In that case, licensing payments can be aggregated accordingly.

In step 220, a portion of the licensing fees are allocated into a content licensing pool for distribution to content licensors. In some cases, the same content licensor may be responsible for more than one content. In that case, licensing payments can be aggregated accordingly.

In step 230, the cumulative time is determined for each content on each content presentation terminal. In one embodiment, the cumulative times are determined from an event log received from each content presentation system. Each time a content presentation terminal is started with one or more content made available, or when there is a change in the content available for a content presentation terminal, one or more events are logged indicating the change in content made available for the corresponding terminal and the time corresponding to that change. In one embodiment, the cumulative time a content is available on a particular terminal for a particular reporting period can be calculated by summing the time durations for each period that the content is available on that terminal. Each period is calculated based on the time difference between the time when that content was made available on the content presentation terminal and the time when that content was made unavailable for that content presentation terminal. For each content available on content presentation terminals at the end of the reporting period, the duration of the active periods are determined by using the time of the end of the reporting period as the end of the period that the corresponding content was available. Similarly, at the beginning of the next reporting period, the duration of the period that the corresponding content was available is determined by using the starting time of that reporting period.

In one embodiment, event logs are received from content presentation systems after a reporting period ends. A report generation program automatically processes the event log to calculate the cumulative time each content was available on each content presentation terminal in each content presentation system for the most recently completed reporting period.

In one embodiment, the content presentation system processes the event log to determine the cumulative time for each content and the cumulative times are transferred to the licensing allocation computer. In some embodiments, timers on the server of the content presentation system track the cumulative times each content is available on each content presentation terminal. For example, a timer corresponding to a particular content on a particular terminal may be reset at the beginning of a reporting period, start incrementing in response to an event that the content is made available on that terminal and stop incrementing in response to an event that the content is made unavailable on that terminal. In another embodiment, the timer represents a count of periodic pulses received by the server from the content presentation terminal during the period each content is available. Other methods of tracking cumulative times may be used.

In step 240, the portion of the content licensing pool is distributed to each content licensor according to the share of total cumulative time the corresponding licensor's content was available. In one embodiment, the share is computed over all content on all content presentation terminals in more than one content presentation system. This share is used to distribute funds in the content licensing pool that are accumulated over the plurality of content systems. In another embodiment, the share is computed over all content on all content presentation terminals in a single content presentation system. This share is used to distribute funds in the content licensing pool that are accumulated for that particular content presentation system. In one embodiment, the licensing fees for multiple content presentation systems are processed by processing each content presentation system individually.

In one embodiment, the content licensing pool represents the funds for one content presentation system allocated to be distributed to the content licensors. The share of the content licensing pool allocated to the licensor of each content is determined by multiplying the content licensing pool by a corresponding fraction.

The numerator of each fraction is the sum of cumulative time that the corresponding content is available on each terminal for all content presentation terminals in that content presentation system. Each content is associated with an integer from 1 to G where G is the number of content available in the content presentation system. Each terminal is associated with an integer from 1 to M where M is the number of content presentation terminals in the content presentation system. Cumulative Time (Content N, Terminal Z) represents the cumulative time for content N on a terminal Z where N is an integer associated with a particular content and Z is the integer associated with a particular terminal.

The denominator is the sum of cumulative time over all content on all content presentation terminals of the content presentation system. The precision of cumulative time tracking can be selected to achieve an acceptable margin of error in the share calculations. Cumulative Time (Content X, Terminal Y) represents the cumulative time for content X on a terminal Y where X is an integer associated with a particular content and Y is the integer associated with a particular terminal. In another embodiment, content licensing pool represents the funds from for multiple content presentation systems allocated to be distributed to content licensors. The share of the content licensing pool allocated to the licensor of Content N is determined by multiplying the content licensing pool by a fraction. The numerator of that fraction is the sum of cumulative time for content N over all content presentation terminals in all content presentation systems. The denominator is the sum of cumulative time over all content in all content presentation terminals of all content presentation systems. The precision of cumulative time tracking can be selected to achieve an acceptable precision in the share calculations.

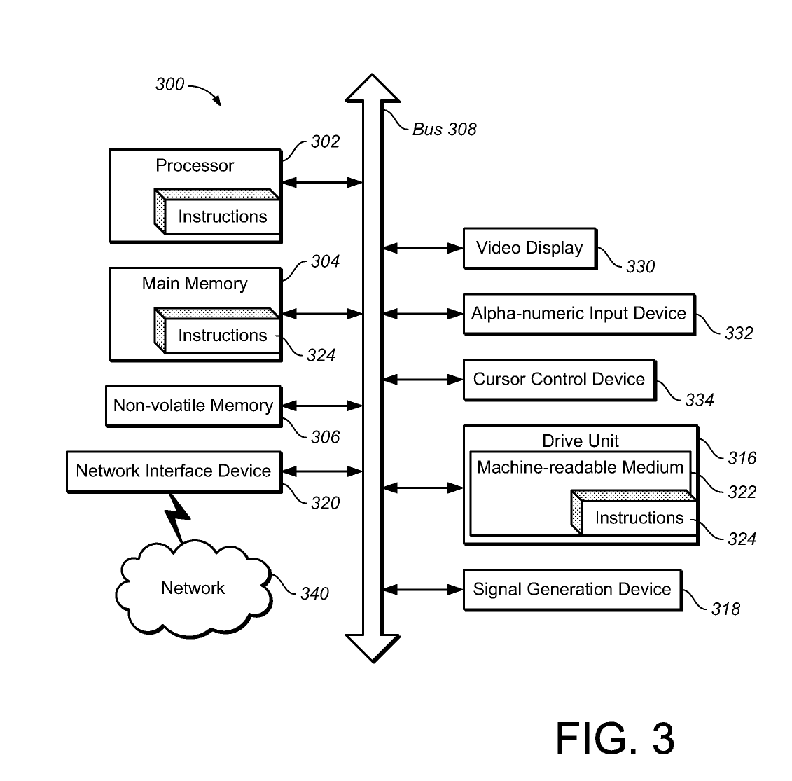

FIG. 3 shows a diagrammatic representation of a machine in the exemplary form of a computer system 300 within which a set of instructions, for causing the machine to perform any one or more of the methodologies discussed herein, may be executed. The machine may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with the server to facilitate operations of the server and/or to access the operations of the server.

The computer system 300 includes a processor 302 (e.g., a central processing unit (CPU) a graphics processing unit (GPU) or both), a main memory 304 and a nonvolatile memory 306, which communicate with each other via a bus 308. In some embodiments, the computer system 300 may be a laptop computer, personal digital assistant (PDA) or mobile phone, for example. The computer system 300 may further include a video display 330 (e.g., a liquid crystal display (LCD) or a cathode ray tube (CRT)). The computer system 300 also includes an alphanumeric input device 332 (e.g., a keyboard), a cursor control device 334 (e.g., a mouse), a disk drive unit 316, a signal generation device 318 (e.g., a speaker) and a network interface device 320. In one embodiment, the video display 330 includes a touch sensitive screen for user input.

In one embodiment, the touch sensitive screen is used instead of a keyboard and mouse. The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media. The software 324 may further be transmitted or received over a network 340 via the network interface device 320.

In one embodiment, the computer system 300 is a server in a content presentation system. The content presentation system has one or more content presentation terminals coupled through the network 340 to the computer system 300. In another embodiment, the computer system 300 is a content presentation terminal in the content presentation system. The computer system 300 is coupled through the network 340 to a server.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

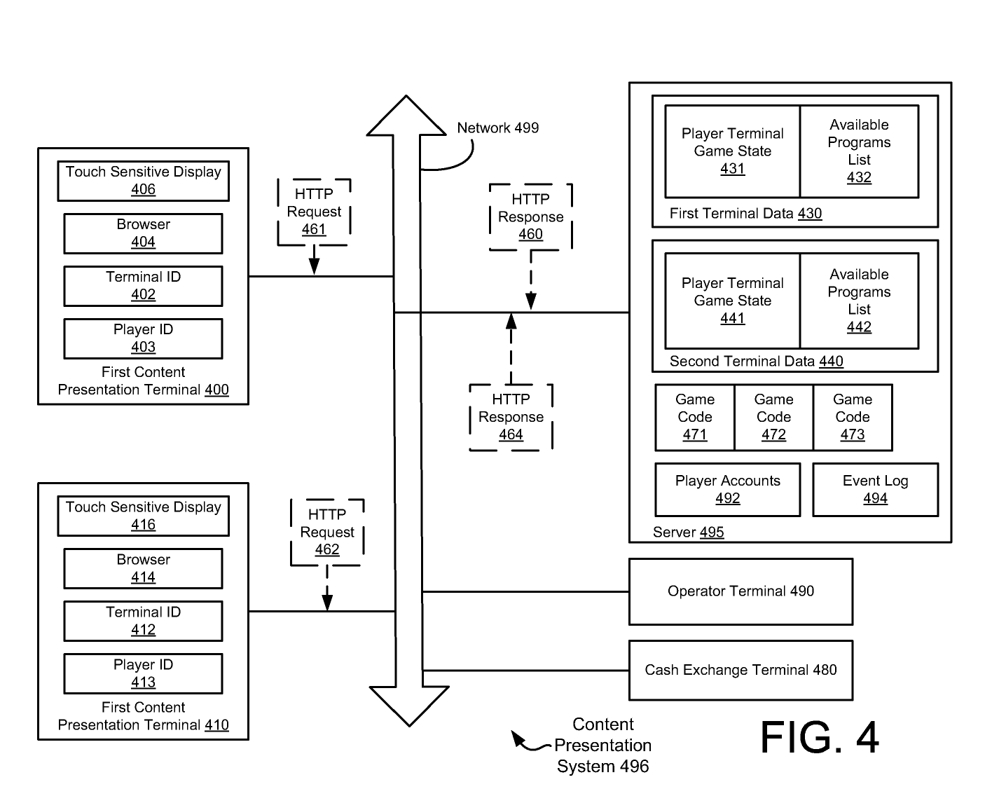

FIG. 4 illustrates a block diagram of one embodiment of a content presentation system 496. In the illustrated embodiment, the content includes interactive games. In other embodiments, the content includes interactive advertising or other multimedia content, for example. In the illustrated embodiment, the system is an event-response system. Other systems for distributing content may be used. Basic functional aspects of these devices, like processors and network interface devices are not shown in order to avoid obscuring the invention.

A server 495 is coupled through a network 499 to a first content presentation terminal 400 and a second content presentation terminal 410, an operator terminal 490 and a cash exchange terminal 480. In one embodiment, the network 499 may comprise a portion of the internet and/or one or more intranets.

The server 495 includes at least one content. In one embodiment, each content is a game. The game code 471 includes the instructions corresponding to a first game stored on the server 495. The game code 472 includes the instructions corresponding to a second game stored on the server 495. The game code 473 includes the instructions corresponding to a third game stored on the server 495. Three games are shown for illustration purposes but more games can be stored on the server to be made available to content presentation systems. A content presentation terminal may also be referred to as a player terminal. Each of these games may be licensed from a different game licensor. Some of these games may be licensed from the same game licensor.

Each game code includes instructions to send Hypertext Transfer Protocol (HTTP) responses in response to HTTP requests from a content presentation terminal to produce an interactive game on the content presentation terminal. In some embodiments, HTTP over secure sockets layer (SSL), also known as HTTPS, is used. In some cases, these interactive games are such that game results are probabilistic and not based on player skills. In other embodiments, the server includes code for an interactive advertising display, games of skill, games based on skills and chance, or other interactive programs.

The server 495 includes a first terminal data 430 and a second terminal data of 440. The first terminal data 430 includes information for games available on the first content presentation terminal 400. The first terminal data 430 includes a game state 431 and an available programs list 432. The second terminal data 440 includes information for games available on the second content presentation terminal 410. The second terminal data 440 includes a game state 441 and an available programs list 442. Two content presentation terminals are shown for illustration purposes but many more content presentation terminals may be connected to the server 495 through the network 499.

The game state 431 includes state information for the game being played on the first player terminal 400. The game state 441 includes state information for the game being played on the second player terminal 410. Each state information includes the state of game play up to that point in the corresponding game session so that the state information may be used to help determine responses to various events at that point in the game session.

An available programs list 432 specifies which of the games stored on the server 495 is available for presentation on the first player terminal 400. An available programs list 442 specifies which of the games available server 495 is available for presentation on the second player terminal 410. In one embodiment, available programs are the programs that are available for selection by a user on the corresponding content presentation terminal.

The operator terminal 490 connected to the server 495 through the network 499 is used to configure the server 495 to make one or more content available for each of the player terminals. In one embodiment, a default set of programs is created to indicate which programs are made available once a content presentation terminal is first powered on or restarted. In another embodiment, a schedule is created such that the content available are changed on each player terminal according to the predetermined schedule. The operator terminal 480 can be used to create player identification cards and player accounts, generate reports and issue “comps” to players. The cash exchange terminal 480 is used by players to transfer money into and out of their account as maintained in the player accounts 492 on the server 495. In one embodiment, the cash exchange terminal 480 is coupled to bill validator to receive currency. In another embodiment, the cash exchange terminal is coupled to a card reader configured to read debit and/or credit cards.

In one embodiment, an event log 494 is created. The event log 494 logs events on the content presentation system. Each time a content presentation terminal is started with one or more content available, or when there is a change in the content that is available on a content presentation terminal, one or more events are logged indicating the change in available content for that terminal and including a time stamp indicating the time of the event. By processing these logged events after the end of a reporting period, the cumulative time a content is available for each terminal may be computed for that reporting period. In other embodiments, timers associated with each content directly track the time a content is available on each content presentation terminal.

The first content presentation terminal 400 includes a touch sensitive display 408 used to present the content and receive user input. Other user input devices may be used such as a keyboard, mouse, voice recognition system, or mouse, for example. User input may initiate an event on the player terminal. The event is transmitted to the server using an HTTP request 461.

At startup, the content presentation terminal 400 requests an internet protocol (IP) address for the player terminal 400 and the IP address of the server 495 stored locally on the content presentation terminal. The content presentation terminal 400 sends an HTTP request that indicates the content presentation terminal 400 has started. A terminal ID 402 is stored at the terminal to identify which of the plurality of player terminals is sending the request to the server. In one embodiment, the terminal ID 402 is assigned by the server 495 during initial configuration of the player terminal 400. The terminal ID 402 is stored in a cookie in the browser 404. The terminal ID 402 is included in the HTTP request as an identification of the player terminal 400.

In one embodiment, a player ID 403 is used to identify the player using the player terminal. The player ID 403 may be determined by a smart card inserted into a card reader coupled to the player terminal 400. In another embodiment, the player ID 403 may be determined by a user name and password, a card with a magnetic stripe, or other means of identification submitted via a user input device coupled to the player terminal 400. The player ID 403 is included in the HTTP request 461 as to identify the player.

The server 495 receives the HTTP request 461 and uses the terminal ID 402 to determine which terminal data to use. During game selection, the server 495 uses an available programs list 432 to determine whether the selected game is available on the content presentation terminal 400. If the game is not made available on the player terminal 400, the server 495 can send an HTTP response 460 that indicates that the game is not available to the player terminal 400.

In some embodiments, access to a game may also depend on the player ID 403. A player may be denied access to games because the there is not enough money in the player account for that player in the player accounts 492. Additionally, a player may be locked out of certain games based on age restrictions or parental controls, for example. If the player game request cannot be serviced, the server 495 can send an HTTP response 460 that indicates the player restriction to the player terminal 400. A page is displayed based on the HTTP response that indicates the player restriction. In one embodiment, the player can go to the cash exchange terminal 480 to deposit more money into their player account and resubmit the game request at the content presentation terminal.

If the game is available on the player terminal 400, the server uses the game code corresponding to the selected game, the event information included in an HTTP request and the game state 431 to process the HTTP request, generate an HTTP response and send the HTTP response to the first content presentation terminal 400. The HTTP response is received by the content presentation terminal 400 and interpreted by a browser 404 to update the touch sensitive display 406. A sequence of these events and responses create an interactive game on the content presentation terminal 400. In some embodiments, the player account is debited for a game play at the beginning of each game. In other embodiments, the player's account may be credited or debited based on the occurrence of certain events during game play.

The second content presentation terminal 410 includes a touch sensitive display 416 used to present the content and receive user input. User input may initiate an event on the player terminal that is transmitted to the server using an HTTP request 462.

A terminal ID 412 is stored at the terminal to identify which of the multiple content presentation terminals is sending the request to the server. In one embodiment, a player ID 413 is used to identify the player using the content presentation terminal. The terminal ID 402 and the player ID 403 is included in the HTTP request 462.

The server 495 uses the terminal ID 412 to determine which terminal data to use. During game selection, the server 495 uses the available program list 442 to determine whether the selected game is available on the content presentation terminal 410. If the game is not available on the player terminal 410, the server 495 can send an HTTP response 464 that indicates that the game is not available to the content presentation terminal 410.

In some embodiments, access to a game may also depend on the player ID 413. If the player game request cannot be serviced, the server 495 can send an HTTP response 464 that indicates the player restriction to the content presentation terminal 410.

If the game is available on the content presentation terminal 410, the server uses the game code corresponding to the selected game, the event information and the game state 441 to create an HTTP response 464 and it sends the HTTP response 464 to the first player terminal 410. The HTTP response 460 is received by the player terminal 410 and interpreted by a browser to update the touch sensitive display 416. A sequence of these events and responses create an interactive game on the player terminal 410. In some embodiments, the player account may be adjusted according to game play.

Although a single exchange of HTTP request and HTTP response is shown in FIG. 4 for illustration purposes, it will be apparent to one skilled in the art that the operation of an interactive game can be implemented using a sequence of HTTP requests and HTTP responses.

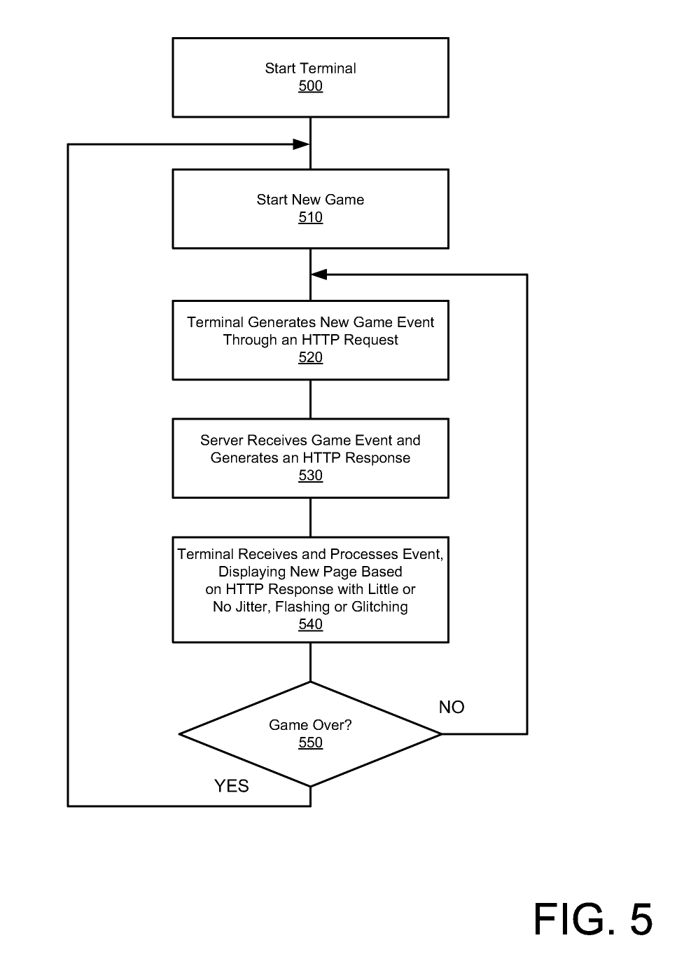

FIG. 5 illustrates one embodiment of a content presentation process of the present invention. In the illustrated embodiment, the content includes interactive games. In other embodiments, the content is interactive advertising, or other multimedia content, for example.

In step 500, a content presentation terminal is powered on or restarted. At startup, the content presentation terminal requests an internet protocol (IP) address for the content presentation terminal and the IP address of the server stored locally on the content presentation terminal. The content presentation terminal sends an HTTP request to the server indicating the content presentation terminal has started. A terminal ID is stored at the terminal to identify which of the plurality of player terminals is sending the request to the server. In one embodiment, the terminal ID is assigned by the server during initial configuration of the content presentation terminal. The terminal ID can be stored in a cookie in the browser on the content presentation terminal. In one embodiment, a player ID is determined by inserting a smart card in the player terminal. In another embodiment, the player ID may be determined by submitting a user name and password on the content presentation terminal.

In one embodiment, a content presentation terminal runs a boot script. The boot script runs a program that monitors a log file. The boot script also starts a program to generate hardware and security events. Generated events are logged in the log file. The boot script also starts an X-windows server and runs a terminal window as a client.

A program that listens for server multicasts is started in the terminal window on the content presentation terminal. The multicasts are generated by a program running on the server. The server runs server software configured to receive HTTPS (HTTP with secure socket layer enabled) packets. In one embodiment, the server runs Apache web server software and is configured to run PHP scripts and a MySQL database server for a database initialized with scripts stored on the server.

When Multiclient receives a multicast with the server address, it starts a browser using a start page. Generally, the start page will be hidden behind a content display window, unless contact with the server is lost. The start page displays a “waiting for host” message when it is visible. JavaScript code within the start page maintains the content display window, forwards events from the monitor daemon, and receives commands from the webserver, passing them to daemon.

The daemon accepts commands passed from the web page, formulates hardware and security events to pass into the web page, and transmits the events to the server. JavaScript embedded in the start page communicates with the daemons by means of two shared files, one file to receive commands from the web page and another file to send hardware and security events to the web page.

In one embodiment, commercial off the shelf (COTS) hardware and software are used to implement the content presentation system. The implementation is not limited to any particular operating system, web server software, networking and display protocols, scripting languages and database management systems. Examples of operating systems include Unix, Linux, BSD, MacOS, and Microsoft Windows XP. Examples of web server software include Apache, Tomcat and Microsoft Internet Information Server. Scripts can be implemented in a number of interpreted, semi-interpreted, or compiled computer languages, such as PHP, Perl, Python, ASP, Java, Ruby and C/C++. Examples of database management software include MySQL, PostgreSQL, Sybase, Progress, Oracle, Berkeley DB, IBM DB2 and Microsoft SQL Server.

In step 510, a new game is requested on the content presentation terminal. In one embodiment, the available content is determined by a default configuration at the startup of the content presentation terminal. In some embodiments, the available content on a content presentation terminal changes according to a predetermined availability schedule. In one embodiment, the request to start a game is a request to start the only game available on the content presentation terminal. In another embodiment, the request to start a game includes a selection of one of several games available on the content presentation terminal.

In step 520, a new game event is generated through an HTTP request. In some cases, the content presentation terminal generates an HTTP request in response to a request to start a game on the content presentation terminal. In other cases, the game event may indicate one of several choices the player has selected at this point in a game. For example, the user may specify a wager. In one embodiment, the HTTP request includes the terminal ID. In another embodiment, the HTTP request includes the terminal ID and the player ID.

In step 530, the server receives the HTTP request and generates an HTTP response.

If the HTTP request is a request to start a game, the server determines the game that is available for play on the content presentation terminal associated with the terminal ID. In some cases, the server may also determine whether the game is authorized for play by the player associated with the player ID based on the funds available in the player account or whether the player is authorized to play that game. When the game starts, the game state is initialized on the server. If the game is available and authorized for the player, the server sends an HTTP response indicating that the game is started. Otherwise, the server sends an HTTP response indicating that the HTTP request cannot be serviced.

If the HTTP request is an event during the game, the event is processed by executing the game code on the server. The game code determines a response based on the event and the game state information. In one embodiment, the server determines the outcome of the wager. The state information is updated on the server.

In step 540, the content presentation terminal receives the HTTP response and processes it. In one embodiment, a browser interprets the HTTP response and updates the display. In one embodiment, the event and response are designed to be small enough relative to network bandwidth and content presentation terminal processing performance so that updates can be transmitted and interpreted quickly enough to avoid jitter, flashing and glitching.

In one embodiment, the start page maintains the window containing various prompts and program screens transmitted by a script called generic.php. Events such as “Card Inserted” (when a player card is inserted into a peripheral associated with the content presentation terminal), “Card Removed” (when a player card is removed from the peripheral associated with the content presentation terminal), and “Power Up” (when the content presentation terminal is turned on) are transmitted by the start page to the server, using an HttpRequest object, with the URL of heartbeat.php as its target URL. Commands, such as “Reload” or “Restart,” are received when the HttpRequest object completes its request. Events are retrieved by JavaScript in the start page. In some embodiments, events are created by a program that monitors the peripherals of the client presentation terminal, security switches and memory usage. In some cases, commands are handled locally in the start page. For example, a Reload reloads generic.php in the application window. In other cases, commands are sent to the operating system. For example, Restart, which terminates the browser, freeing memory) by writing the command to a command pipe.

A command processing program executes commands received from the command pipe. In one embodiment, heartbeat.php processes events generated on the content presentation terminal and generic.php generates web pages which are sent back to the content presentation terminal to display the results of the various events. The start page is an interface between the operating system on the content presentation terminal and the scripts resident on the server.

When a content presentation terminal communicates with heartbeat.php, the script checks for a SerialNumber cookie. This cookie contains the content presentation terminal's id, type, IP number, maker and serial number. If the IP number in the cookie does not match the content presentation terminal's assigned IP number in the database, or the IP number in the HTTPS request does not match the cookie, the cookie is deleted and no further processing takes place. If the content presentation terminal does not have a SerialNumber cookie, and the IP number in the HTTPS request is found in the database and no other content presentation terminal is active with that IP number, the script will set the cookie. Once a SerialNumber cookie is set and validated, the system is ready to present content.

When a content presentation terminal sends an event after not doing so for an interval of 60 seconds or more, event log entries are created that indicate the start and end of the period of inactivity. The menu should change from whatever the current menu was to NULL at the time the content presentation terminal stopped responding, then back, at the current time. An event log entry is created when the content presentation terminal is first made available.

Step 550, it is determined whether the game is over. If the game is over, step 510 is performed. If the game is not over, step 520 is performed.

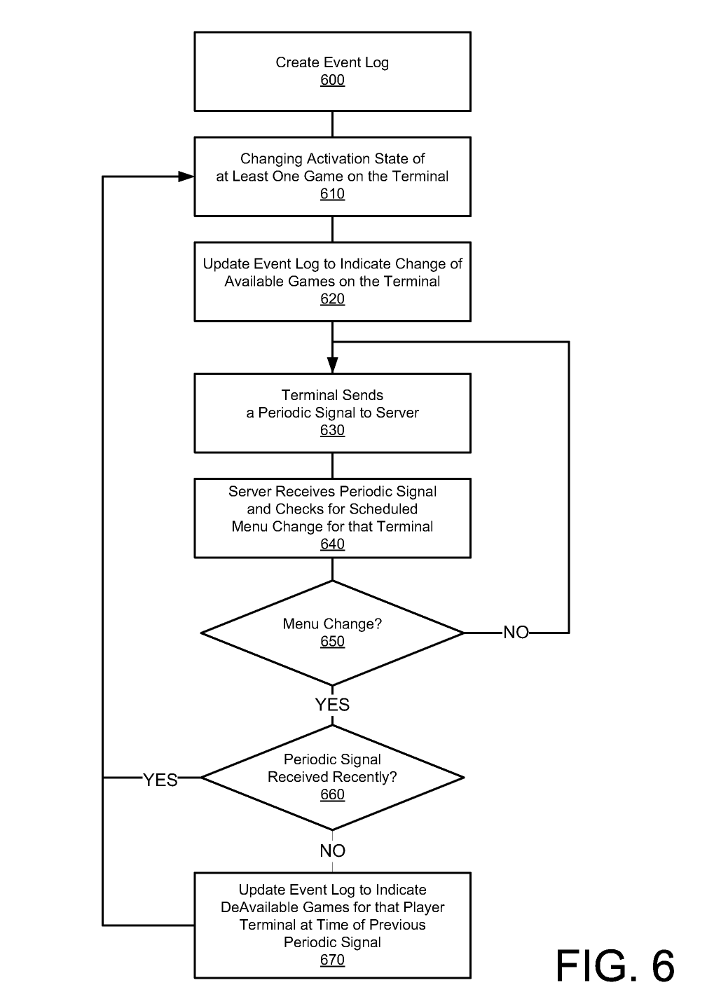

FIG. 6 illustrates one embodiment of a process to track cumulative time each content is available for presentation on a content presentation terminal according to one embodiment of the present invention.

In step 600, an event log is created on the server for a content presentation terminal. In one embodiment, the event log is created when a new content presentation terminal is added to the content presentation system. In other embodiments, the event log is created when a new licensing period is started.

In step 610, the availability of at least one game is changed for the content presentation terminal. At the startup of a content presentation terminal, the availability of the games changes from undefined to a default menu of available games.

In step 620, an event log is updated to include a record indicating the change in available games on the content presentation terminal. The time of the last periodic signal is included in the record.

In step 630, the content presentation terminal sends a periodic signal to the server. In one embodiment, the periodic signal is sent every thirty seconds.

In step 640, the server receives the periodic signal. The server compares the time against a scheduled menu change file. For example, different games may be available on content presentation terminals in the morning and in the evening. The schedule may also be different depending on the location of the content presentation terminals.

In step 650, if the time comparison against the scheduled menu change file indicates that the menu of available games should change for the content presentation terminal, step 660 is performed. Otherwise, step 630 is performed.

In step 660, it is determined whether the periodic signal was recently received. In one embodiment, if it has been more than one period since the last periodic signal was received, then the last periodic signal is not considered to have been recently received. For example, if the periodic signal is scheduled to be received each 30 seconds and it has been more than 30 seconds since the last periodic signal was received, the periodic signal is not considered to have been recently received. In other embodiments, the periodic signal is considered recently received if it was received within the last N periodic signals, where N is a predetermined number. If the periodic signal was recently received, step 610 is performed. Otherwise step 670 is performed.

In step 670, the event log is updated to indicate that the games available on the content presentation terminal were made unavailable at the time the previous, non-recently received periodic signal was received. For example, the interruption of periodic signals may happen because the content presentation terminal was shut down or because of some technical difficulties that prevent communication with the server. In either case, the game content is not available for use on the content presentation terminal during the period since the previous, non-recently received periodic signal was received. Step 610 is then performed.

In one embodiment, the cumulative time a content is available on a particular terminal for a particular reporting period can be calculated by summing the time durations for each period that the content is available on that terminal. Each period is calculated based on the time difference between the time stamp for the record in which that content was available on the content presentation terminal and the time stamp for the record in which that content was made unavailable for that content presentation terminal. In one embodiment, a report generation program automatically processes the event log to calculate the cumulative time a content is made available for each terminal for a reporting period.

In other embodiments, timers associated with each content directly track the time each content is available on each content presentation terminal. For example, a timer corresponding to a particular content on a particular terminal may be reset at the beginning of a reporting period, start incrementing in response to an event indicating that the content is made available on that content presentation terminal and stop incrementing in response to an event that the content is made unavailable on that content presentation terminal.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A system for distributing licensing fees comprising:
at least one content presentation system, the at least one content presentation system having a plurality of content;
a means for receiving licensing fees from at least one content presentation system licensee, the at least one content presentation system licensee licensing a portion of the at least one content presentation system;
a means for distributing a portion of the licensing fees into a licensing fund;
a means for tracking a plurality of cumulative times, each of the plurality of cumulative times being the cumulative time a corresponding content is made available over all of the plurality of content presentation terminals in a period;
a means for tracking a total cumulative time, the total cumulative time being the sum of the total cumulative time of all the content over all of the plurality of content presentation terminals in a period; and
a means for distributing a share of licensing fund to each of a plurality of licensors, each of the plurality of licensors licensing at least one of the plurality of content, the share of the licensing funds based on the fraction of the cumulative time for the corresponding content divided by the total cumulative time.

2. The system of claim 1 wherein the at least one content presentation system is a single content presentation system, the content presentation system having all of the plurality of content presentation terminals, the at least one licensee is a single licensee, the licensee licensing the content presentation system.

3. The system of claim 1 wherein the at least content presentation system comprises a plurality of content presentation systems, each of the plurality of content presentation systems having a portion of the plurality of content presentation terminals, the at least one licensee comprising a plurality of licensees, each of the plurality of licensees licensing at least one of the plurality of content presentation systems.

4. The system of claim 1 wherein each of the plurality of content is an interactive game.

5. The system of claim 2 wherein the interactive game is probabilistic and non-skills based.

6. The system of claim 1 wherein at least one of the plurality of content is an interactive advertising program.

7. The system of claim 1 further comprising a means for distributing a portion of the licensing fees to a content presentation system licensor.

8. A method for distributing licensing fees comprising:
receiving licensing fees from at least one licensee, an at least one licensee licensing a portion of at least one content presentation system having a plurality of content presentation terminals;
distributing a portion of the licensing fees into a licensing fund;
tracking a plurality of cumulative times, each of the plurality of cumulative times being the cumulative time a corresponding content is made available over all of the plurality of content presentation terminals in a period;
tracking a total cumulative time, the total cumulative time being the sum of the total cumulative time of all the content over all of the plurality of content presentation terminals in a period; and
distributing a share of licensing fund to each of a plurality of licensors, each of the plurality of licensors licensing at least one of the plurality of content, the share of the licensing funds based on the fraction of the cumulative time for the corresponding content divided by the total cumulative time.

9. The method of claim 8 wherein the at least one content presentation system is a single content presentation system, the content presentation system having all of the plurality of content presentation terminals, the at least one licensee is a single licensee, the licensee licensing the content presentation systems.

10. The method of claim 8 wherein the at least one content presentation system comprises a plurality of content presentation systems, each of the plurality of content presentation systems having a portion of the plurality of content presentation terminals, the at least one licensee comprising a plurality of licensees, each of the plurality of licensees licensing at least one of the plurality of content presentation systems.

11. The method of claim 8 wherein each of the plurality of content is an interactive game.

12. The method of claim 11 wherein the interactive game is probabilistic and non-skills based.

13. The method of claim 8 wherein at least one of the plurality of content is an interactive advertising program.

14. The method of claim 8 further comprising distributing a portion of the licensing fees to a content presentation system licensor.

15. A machine-readable medium that provides instructions for a processor, which when executed by the processor cause the processor to perform a method for distributing licensing fees comprising:
receiving licensing fees from at least one licensee, an at least one licensee licensing a portion of at least one content presentation system having a plurality of content presentation terminals;
distributing a portion of the licensing fees into a licensing fund;
tracking a plurality of cumulative times, each of the plurality of cumulative times being the cumulative time a corresponding content is made available over all of the plurality of content presentation terminals in a period;
tracking a total cumulative time, the total cumulative time being the sum of the total cumulative time of all the content over all of the plurality of content presentation terminals in a period; and
distributing a share of licensing fund to each of a plurality of licensors, each of the plurality of licensors licensing at least one of the plurality of content, the share of the licensing funds based on the fraction of the cumulative time for the corresponding content divided by the total cumulative time.

16. The machine readable medium of claim 15 wherein the at least one content presentation system is a single content presentation system, the content presentation system having all of the plurality of content presentation terminals, the at least one licensee is a single licensee, the licensee licensing the content presentation systems.

17. The machine readable medium of claim 15 wherein the at least one content presentation system comprises a plurality of content presentation systems, each of the plurality of content presentation systems having a portion of the plurality of content presentation terminals, the at least one licensee comprising a plurality of licensees, each of the plurality of licensees licensing at least one of the plurality of content presentation systems.

18. The machine readable medium of claim 15 wherein each of the plurality of content is an interactive game.

19. The machine readable medium of claim 18 wherein the content is probabilistic and non-skills based.

20. The machine readable medium of claim 15 wherein at least one of the plurality of content is an interactive advertising program.

21. The machine readable medium of claim 15 further comprising a means for distributing a portion of the licensing fees to a content presentation system licensor.
